(19) United States
(12) Patent Application Publication
(10) Pub. No.: US 2026/0336247 A1
(43) Pub. Date: Oct. 29, 2026

(54) COMPOSITE CONTAINER ROTARY FORMING APPARATUS

(71) Applicant: CHUMPOWER MACHINERY CORPORATION, Taichung City (TW)

(72) Inventors: SHU-LIN XIE, Taichung City (TW); Ching-Pin Wang, Taichung City (TW); Pin-Nan Lee, Taichung City (TW); Chih-Huang Wei, Taichung City (TW); CHIEN-HUNG LIN, Taichung City (TW); PO CHENG LAI, Taichung City (TW)

(21) Appl. No.: 19/656,281

(22) Filed: Apr. 23, 2026

(30) Foreign Application Priority Data
Apr. 25, 2025 (TW) 114115795

(51) Int. Cl. B31B 50/74; B29C 57/12; B31B 50/06

(52) U.S. Cl. CPC B31B 50/74; B29C 57/12; B31B 50/062

(57) ABSTRACT

A composite container rotary forming apparatus is provided and includes a main frame; a feeding mechanism connected to a side of the main frame, the feeding mechanism comprising a pedestal and a linear shuttle mechanism connected above the pedestal, with at least two stack magazines provided above the linear shuttle mechanism for respectively receiving paper containers and plastic containers; a main drive motor provided on the main frame, the main drive motor driving a rotary turret to rotate; and a plurality of rim curling stations provided on the rotary turret for performing an rim-curling operation on upper rims of the paper container and the plastic container to form a composite container.

### FIELD OF INVENTION

The present disclosure relates generally to forming technologies for composite containers. More specifically, the present disclosure relates to a rotary forming apparatus configured for the rapid and high-volume mass production of such containers by means of a rim-curling process.

### BACKGROUND OF THE INVENTION

Currently, disposable cups are widely utilized in the market to contain high-temperature beverages. Due to the elevated temperature of the cup body during use, an auxiliary outer sleeve is typically required for thermal protection. One such example is disclosed in Chinese Patent No. 200920148189.3, titled “Disposable Paper/Plastic Insulated Cup.” This patent discloses a disposable paper/plastic insulated cup comprising an inner vessel and an annular insulating sleeve disposed on an outer side of the inner vessel. The upper and lower ends of the annular insulating sleeve are fixedly connected to the upper and lower ends (or proximate thereto) of the inner vessel, such that the annular insulating sleeve and the inner vessel are spaced apart to define an insulating air gap. In this double-layer construction, a plastic inner vessel is nested within a printable paper auxiliary sleeve. While this configuration provides effective thermal insulation and prevents leakage via the plastic layer, the inner and outer bodies are bonded using an adhesive. This use of glue presents significant challenges during the recycling process, as it is difficult to cleanly separate the plastic and paper components. Residual adhesive remains on the materials even after separation, thereby increasing the complexity, processing steps, and overall costs of reclamation and recycling treatments.

Beyond beverage cups, the continued expansion of the “take-out” and “take-away” markets has heightened the importance of paper-based meal containers within the catering industry. Selecting an appropriate takeout container not only enhances the aesthetic presentation and perceived quality of the food but also establishes a favorable initial impression for the consumer. Currently, polygonal takeout containers available on the market are predominantly single-layer structures composed either of plastic or of paper with a functional coating. Although certain single-layer materials are microwave-safe, the surface temperature of the takeout container becomes excessively high after heating, necessitating the use of a carrying bag or additional paper wrapping for handling, which results in significant consumer inconvenience. The inventor has previously filed Taiwan Invention Patent No. I828379, Invention Patent Application No. 113121092, and Invention Patent Application No. 113133547. These prior applications primarily address circular composite containers, specifically improving container designs and forming mechanisms for the rim-curling of such circular structures. Those inventions utilize pressing technologies to achieve rim-curling in double-layer containers to resolve deficiencies in thermal handling and recycling. However, because cups and takeout containers are typically single-use items, there is a substantial and continuous market demand. Consequently, developing a means to effectively and rapidly mass-produce these containers remains a critical technical challenge in the industry.

### SUMMARY OF THE INVENTION

In view of the limitations in the prior art, specifically the inability to accelerate production speeds and the tendency for containers to adhere to the mold during forming, which causes the mold to lift the container upon withdrawal and interrupt the production line. The inventor has developed a rotary forming apparatus configured for rapid and high-volume mass production.

It is an object of the present disclosure to provide an apparatus that enables two containers of different materials to be rapidly integrated into a single composite container. A composite container rotary forming apparatus comprises a main frame; a feeding mechanism connected to a side of the main frame, the feeding mechanism comprising a pedestal and a linear shuttle mechanism connected above the pedestal, the linear shuttle mechanism having at least two stack magazines disposed above for respectively receiving paper containers and plastic containers; a main drive motor provided on the main frame, the main drive motor driving a rotary turret to rotate; and a plurality of rim curling stations provided on the rotary turret. Each rim curling station comprises a support base, a station drive motor provided above the support base, and a rotating head connected below the station drive motor. A bottom of the rotating head is provided with a cam track and the rotating head is connected to a forming mandrel. A side of the rotating head is provided with a plurality of curling mechanisms, each comprising an articulated base, a curling roller, two spring supports, and two springs. The two spring supports are respectively connected to two sides of the articulated base and are further connected by an actuation plate. A cam follower is provided above the articulated base and is disposed within the cam track, the cam track being provided with a cam dwell at a position corresponding to each curling mechanism. Each spring support has two ends, wherein one end is fixed on the support base and the other end is connected to a side of the articulated base by one of the springs. Two sides of the actuation plate are respectively connected to an actuator cylinder such that the articulated base generates a displacement when the actuator cylinder moves the actuation plate, thereby driving the cam follower. A bottom of the rim curling station is provided with an elevating platform, a bottom of the elevating platform being connected to a lift actuator. A discharge mechanism is connected to a side of the main frame, the discharge mechanism comprising a mounting base and an extraction assembly connected above the mounting base.

The composite container rotary forming apparatus as above described, wherein the forming mandrel corresponds to a shape of the composite container.

The composite container rotary forming apparatus as above described, wherein the shape of the composite container is selected from the group consisting of circular, rectangular, and polygonal.

The composite container rotary forming apparatus as above described, wherein the linear shuttle mechanism comprises a linear guide rail connected to a drive cylinder, a front end of the drive cylinder having a transfer gripper configured to receive the paper container and the plastic container from the stack magazines.

The composite container rotary forming apparatus as above described, wherein the pedestal further comprises a lift cylinder connected to the linear guide rail of the linear shuttle mechanism, the lift cylinder being configured to lift or lower the linear shuttle mechanism.

The composite container rotary forming apparatus as above described, wherein the extraction assembly comprises a discharge rail connected to a transfer cylinder, a front end of the transfer cylinder having a discharge gripper configured to grip the composite container.

The composite container rotary forming apparatus as above described, wherein a product collection magazine is provided between the mounting base and the extraction assembly, and the discharge gripper is movable to the product collection magazine for storage after gripping the composite container.

The composite container rotary forming apparatus as above described, wherein each of the rim curling stations is connected to a hot-air heater configured to deliver hot air to an edge of the forming mandrel through a hot-air duct to plasticize an upper rim of the plastic container.

The present disclosure utilizes a rotary turret equipped with a plurality of rim curling stations. The main drive motor drives the rotary turret to rotate; as each rim curling station is moved to a position proximate to the feeding mechanism, the stacked paper container and plastic container are received. The rim curling station subsequently performs a rim-curling operation on the upper rims of the paper container and the plastic container to form the composite container. The discharge mechanism then extracts the composite container from the rim curling station, allowing the rim curling station to receive a subsequent paper container and plastic container from the feeding mechanism to continue the rim-curling operations, thereby achieving rapid production.

### BRIEF DESCRIPTION OF THE DRAWINGS

FIG. 1 is a schematic perspective view illustrating the structure of the present disclosure.

FIG. 2 is a schematic diagram of the feeding mechanism and the rim curling station of the present disclosure.

FIG. 3 is a schematic top view of the rim curling station of the present disclosure.

FIG. 4 is a schematic diagram illustrating the feeding operation of the feeding mechanism of the present disclosure.

FIG. 5 is a schematic side cross-sectional view of the rim curling station of the present disclosure.

FIG. 6 is a schematic diagram of the rim curling mechanism of the present disclosure.

FIG. 7 is a schematic diagram illustrating the operation of the rim curling mechanism of the present disclosure.

FIG. 8 is a schematic diagram illustrating the rotational operation of the rim curling mechanism and the forming mandrel of the present disclosure.

FIG. 9 is a schematic diagram of the hot-air heater of the present disclosure.

FIG. 10 is a schematic diagram of the discharge mechanism of the present disclosure.

FIG. 11 is a schematic diagram illustrating the operation of the discharge mechanism of the present disclosure.

### DETAILED DESCRIPTION OF THE PREFERRED EMBODIMENTS

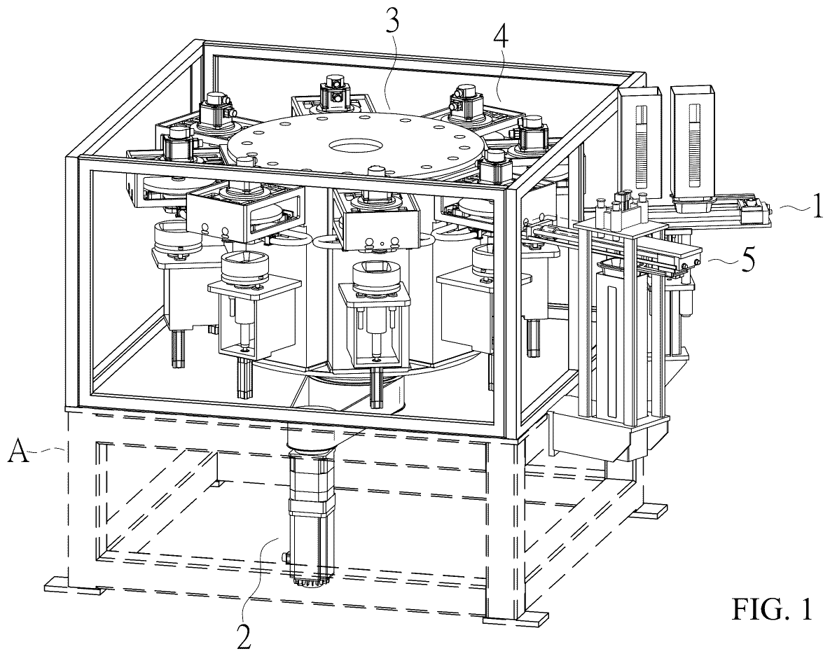

The following describes the features of the present disclosure in detail through exemplary embodiments. Referring first to FIG. 1, a composite container rotary forming apparatus is shown, comprising a main frame A; a feeding mechanism 1 connected to a side of the main frame A; a main drive motor 2 provided on the main frame A, the main drive motor 2 driving a rotary turret 3 to rotate; a plurality of rim curling stations 4 provided on the rotary turret 3; and a discharge mechanism 5 connected to a side of the main frame A.

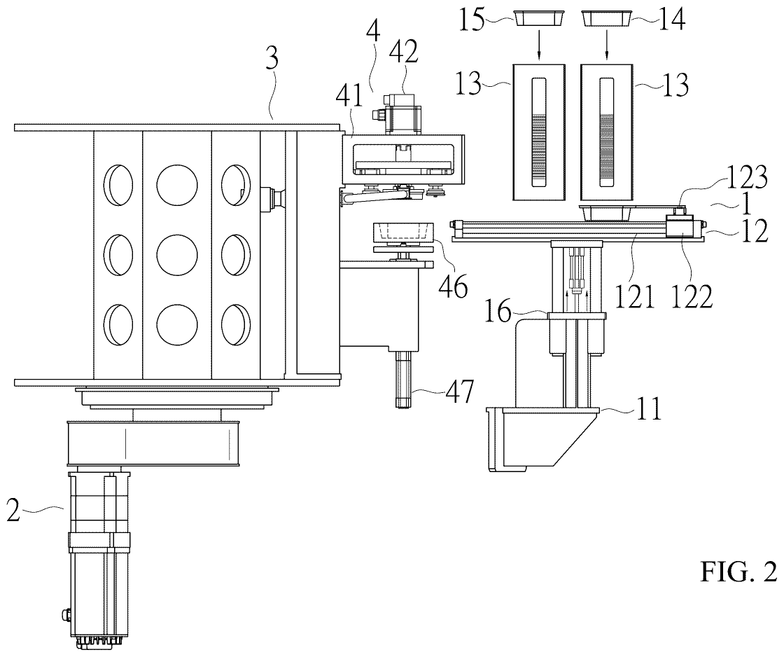

Referring to FIG. 2, the feeding mechanism 1 comprises a pedestal 11, a linear shuttle mechanism 12 connected above the pedestal 11, and at least two stack magazines 13 provided above the linear shuttle mechanism 12. The two stack magazines 13 are configured for respectively receiving paper containers 14 and plastic containers 15. The linear shuttle mechanism 12 comprises a linear guide rail 121 connected to a drive cylinder 122. A front end of the drive cylinder 122 is provided with a transfer gripper 123, which is configured to receive the paper container 14 and the plastic container 15 from the stack magazines 13. In a further embodiment of the present disclosure, a lift cylinder 16 is provided between the pedestal 11 and the linear shuttle mechanism 12; the lift cylinder 16 is connected to the linear guide rail 121 and is configured to vertically displace the linear shuttle mechanism 12.

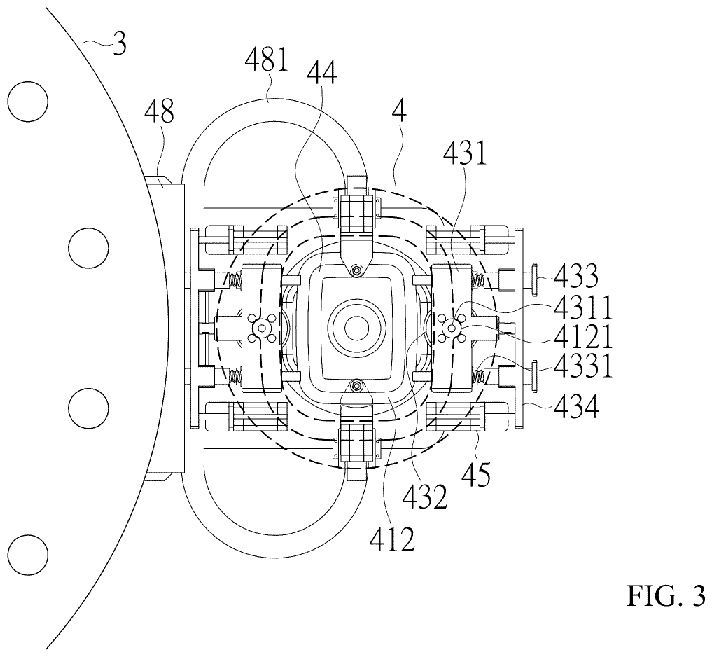

Referring to FIGS. 2 and 3, each of the rim curling stations 4 is respectively provided on a periphery of the rotary turret 3. The rim curling station 4 at least comprises a support base 41, a station drive motor 42 provided above the support base 41, and a rotating head 411 connected below the station drive motor 42. The rotating head 411 is driven to rotate by the station drive motor 42. A bottom of the rotating head 411 is provided with a cam track 412, and a center of the rotating head 411 is connected to a forming mandrel 44. A plurality of curling mechanisms 43 are provided at a side of the rotating head 411 and the forming mandrel 44. Each curling mechanism 43 comprises an articulated base 431, a curling roller 432, two spring supports 433, and two springs 4331. The two spring supports 433 are respectively connected to two sides of the articulated base 431 and are interconnected by an actuation plate 434. A cam follower 4311 is provided above the articulated base 431 and is disposed within the cam track 412. The cam track 412 is provided with a cam dwell 4121 at a position corresponding to each curling mechanism 43. Each spring support 433 has two ends, wherein one end is fixed on the support base 41 and the other end is connected to a side of the articulated base 431 by one of the springs 4331. Two sides of the actuation plate 434 are respectively connected to an actuator cylinder 45 such that the articulated base 431 generates a displacement when the actuator cylinder 45 moves the actuation plate 434, thereby driving the cam follower 4311. In an embodiment of the present disclosure, a bottom of the rim curling station 4 is provided with an elevating platform 46, a bottom of the elevating platform 46 being connected to a lift actuator 47. The elevating platform 46 is configured to receive a pre-curled composite container B.

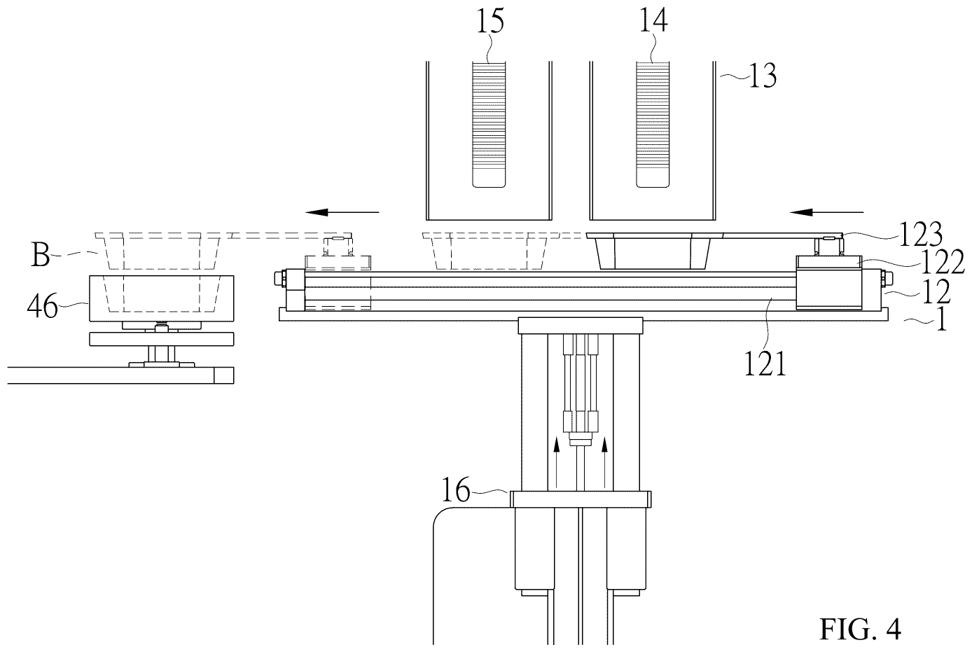

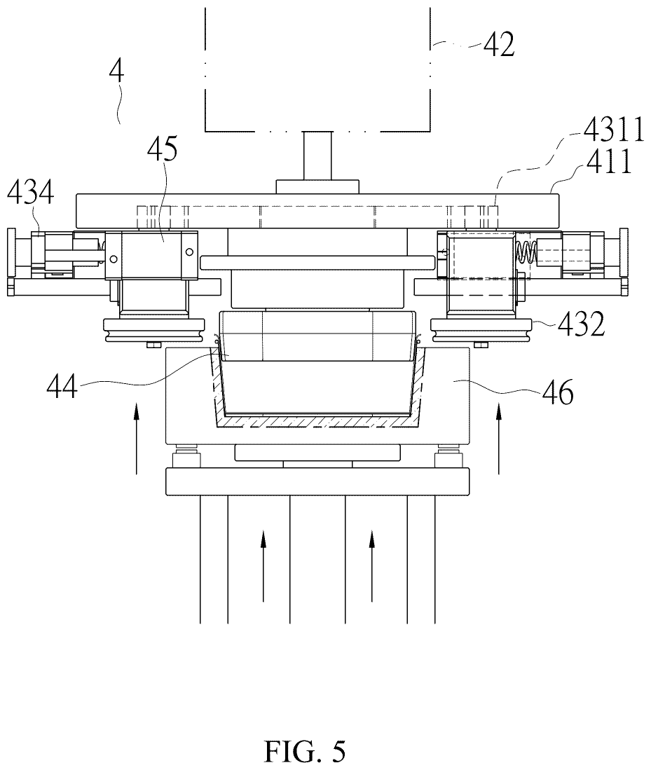

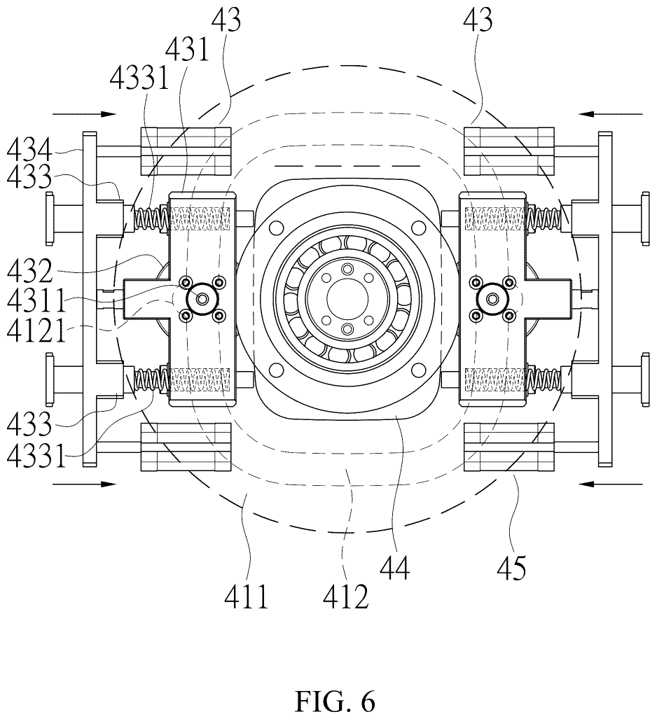

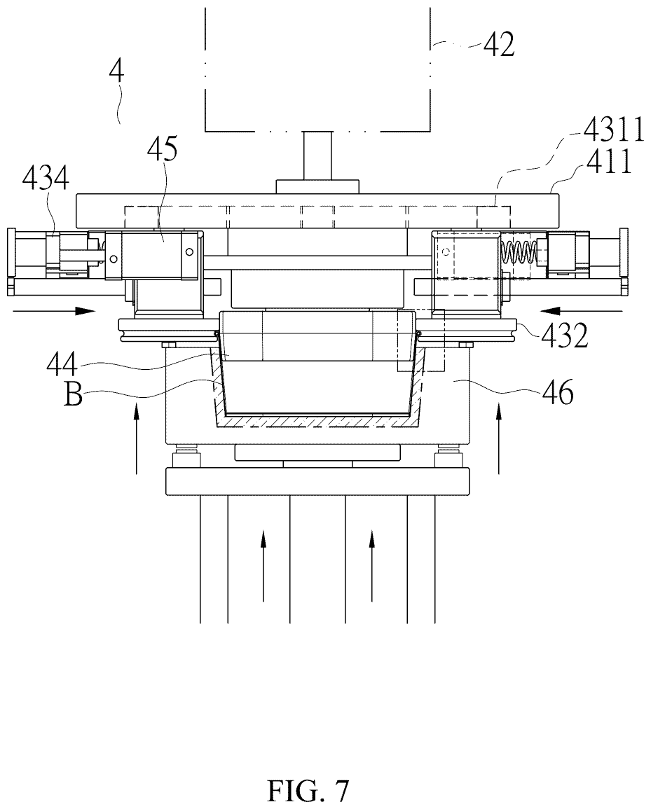

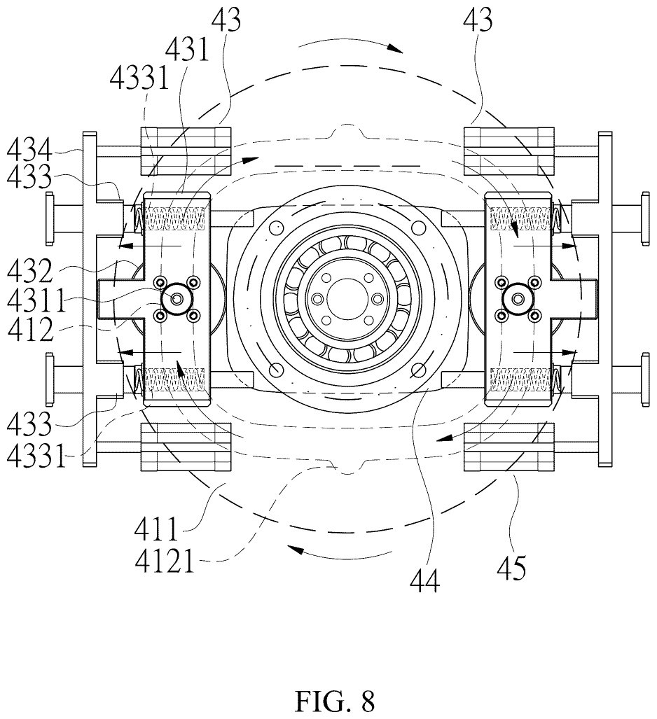

Referring to FIGS. 4 through 8, when the transfer gripper 123 at the front end of the drive cylinder 122 moves to a bottom of the first stack magazine 13, the transfer gripper 123 receives the paper container 14. The transfer gripper 123 then moves to the second stack magazine 13 to place the plastic container 15 above the paper container 14, thereby constituting the pre-curled composite container B. Subsequently, the linear shuttle mechanism 12 displaces the pre-curled composite container B to the elevating platform 46. The lift actuator 47 pushes the elevating platform 46 upward until the pre-curled composite container B on the elevating platform 46 fits with the forming mandrel 44 (as shown in FIG. 5). Referring to FIG. 6 in conjunction with FIG. 5, in this embodiment of the present disclosure, the cam follower 4311 is biased by the force of the spring 4331 to abut against an inner edge of the cam track 412, which positions the curling roller 432 proximate to the forming mandrel 44. Accordingly, for the pre-curled composite container B to reach the proper forming position, the curling roller 432 must first be moved away from the forming mandrel 44 to define a curling clearance. At the initiation of each operation, the cam follower 4311 must be located in the cam dwell 4121. Thus, the actuator cylinder 45 must push the actuation plate 434 outward to move the cam follower 4311 on the articulated base 431 into the cam dwell 4121, at which time the curling roller 432 is moved away from the forming mandrel 44 (as shown in FIG. 5). After the elevating platform 46 rises to a predetermined position, the actuator cylinder 45 retracts the actuation plate 434, and the force of the spring 4331 pushes the articulated base 431 toward the forming mandrel 44. Consequently, the cam follower 4311 leaves the cam dwell 4121 and abuts against the inner edge of the cam track 412 (as shown in FIG. 7). The station drive motor 42 then drives the rotating head 411 to rotate, causing the cam follower 4311 to displace along the rotational trajectory of the cam track 412. This action links the curling roller 432 under the articulated base 431 to perform the rim-curling operation on the pre-curled composite container B (as shown in FIG. 8).

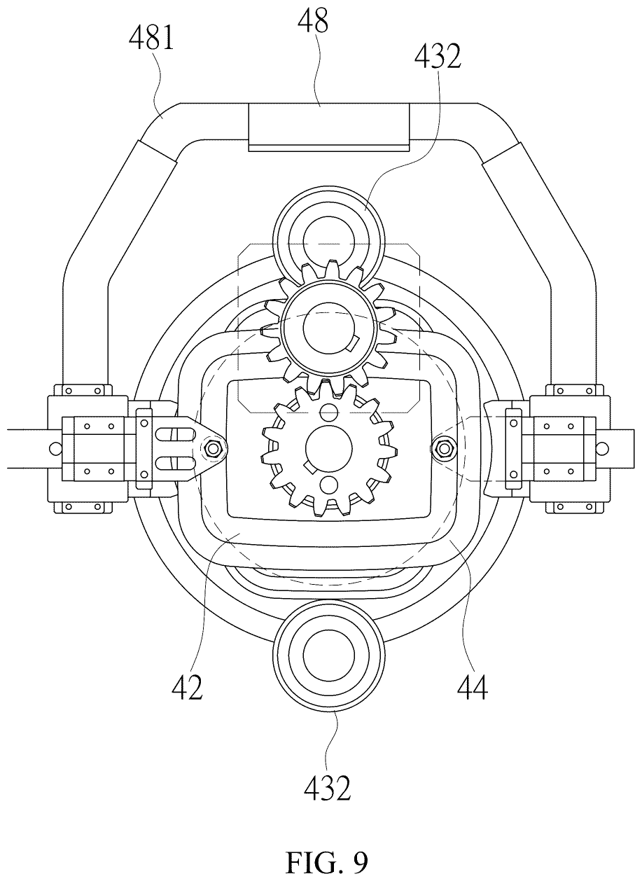

Referring to FIG. 9 in conjunction with FIG. 3, once the pre-curled composite container B is fitted onto the forming mandrel 44, a hot-air heater 48 provided on the rim curling station 4 is actuated to plasticize the upper rim of the plastic container 15. In one embodiment, the hot-air heater 48 delivers hot air to the edge of the forming mandrel 44 through a hot-air duct 481 to facilitate this plasticizing process. The forming mandrel 44 is configured to correspond to the specific geometry of the composite container B, which may include, but is not limited to, circular, rectangular, or other polygonal shapes. Consequently, the composite container B may take the form of various vessels such as cups, bowls, boxes, or plates.

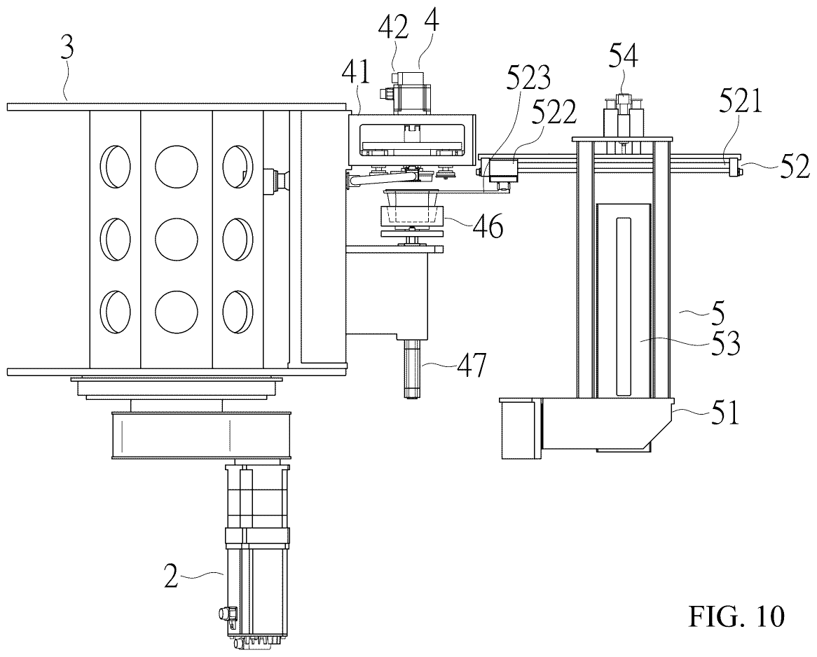

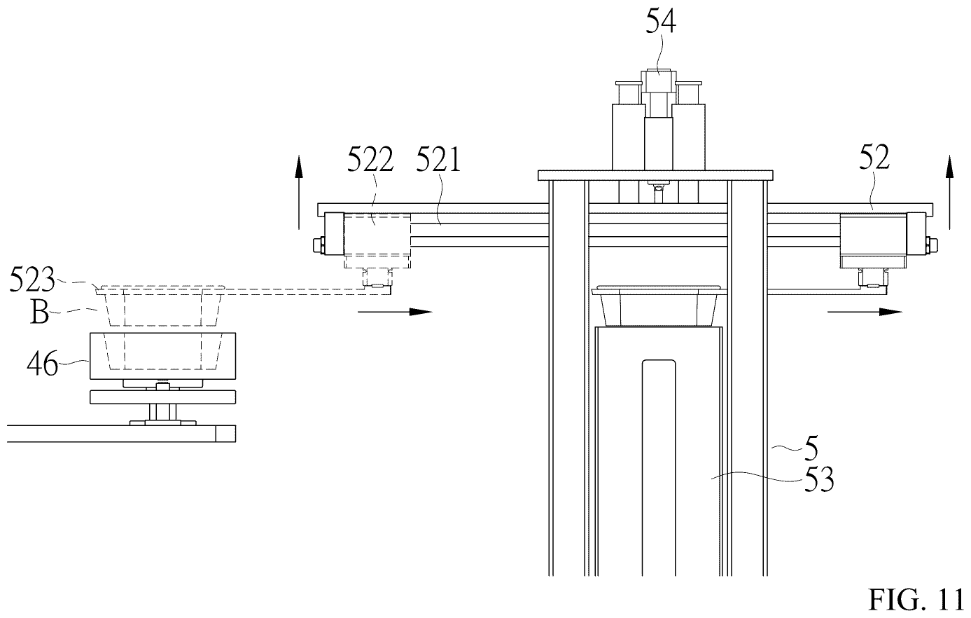

Referring now to FIGS. 10 and 11, upon completion of the rim-curling operation by a rim curling station 4, the rotation of the rotary turret 3 advances the rim curling station 4 toward a discharge mechanism 5 disposed adjacent to the feeding mechanism 1. The discharge mechanism 5 comprises a mounting base 51 secured to the main frame A, with an extraction assembly 52 disposed above the mounting base 51. The extraction assembly 52 comprises a discharge rail 521 connected to a transfer cylinder 522. A front end of the transfer cylinder 522 is provided with a discharge gripper 523 configured to grip the finished composite container B. A product collection magazine 53 is positioned between the mounting base 51 and the extraction assembly 52, such that the discharge gripper 523 may transport the composite container B to the product collection magazine 53 for collection. Additionally, a vertical lift actuator 54 is provided at a top end of the mounting base 51 and is connected to the extraction assembly 52 to provide vertical displacement for the extraction assembly 52 during the removal cycle.

The present disclosure provides several technical advantages:

The use of a rotating head to drive each rim curling station allows each unit to perform rim-curling operations on a composite container B independently and concurrently, thereby accelerating production rate and increasing operational efficiency.

The rotary configuration optimizes the footprint of the main frame, reducing the overall machine size and enhancing space utilization within a production facility.

The rotary pressing method ensures that the rim-curling of the double-layer container is significantly smoother and more uniform. Furthermore, this method ensures the top edge of the plastic inner layer is tightly biased against the body of the paper outer layer, resulting in superior hemming that eliminates sharp edges and prevents injury to the end-user.

The embodiments described above are merely preferred examples of the present disclosure and are not intended to limit the scope of the disclosure. Simple equivalent changes, modifications, or substitutions made in accordance with the spirit of the disclosure and the scope of the following claims shall remain within the protected technical scope of the present disclosure.

What is claimed is:

1. A composite container rotary forming apparatus, comprising:
a main frame;
a feeding mechanism connected to a side of the main frame, the feeding mechanism comprising a pedestal, a linear shuttle mechanism connected above the pedestal, and at least two stack magazines provided above the linear shuttle mechanism, the at least two stack magazines configured for respectively receiving paper containers and plastic containers;
a main drive motor provided on the main frame, the main drive motor driving a rotary turret to rotate;
a plurality of rim curling stations provided on the rotary turret; and
a discharge mechanism connected to a side of the main frame, the discharge mechanism comprising a mounting base and an extraction assembly connected above the mounting base.

2. The composite container rotary forming apparatus according to claim 1, wherein the linear shuttle mechanism comprises a linear guide rail connected to a drive cylinder, a front end of the drive cylinder having a transfer gripper configured to receive a paper container and a plastic container from the at least two stack magazines.

3. The composite container rotary forming apparatus according to claim 1, wherein the pedestal of the feeding mechanism further comprises a lift cylinder connected to the linear guide rail of the linear shuttle mechanism, the lift cylinder being configured to vertically displace the linear shuttle mechanism.

4. The composite container rotary forming apparatus according to claim 1, wherein each of the plurality of rim curling stations comprises:
a support base;
a station drive motor provided above the support base;
a rotating head connected below the station drive motor, a bottom of the rotating head being provided with a cam track, the rotating head being connected to a forming mandrel;
a plurality of curling mechanisms provided at a side of the rotating head, each curling mechanism comprising an articulated base, a curling roller, two spring supports, and two springs, the two spring supports being respectively connected to two sides of the articulated base and interconnected by an actuation plate;
a cam follower provided above the articulated base and disposed within the cam track, the cam track being provided with a cam dwell at a position corresponding to each curling mechanism;
wherein each spring support has a first end fixed on the support base and a second end connected to a side of the articulated base by one of the two springs;
wherein two sides of the actuation plate are respectively connected to an actuator cylinder such that the articulated base generates a displacement when the actuator cylinder moves the actuation plate, thereby driving the cam follower; and
an elevating platform provided at a bottom of the rim curling station, a bottom of the elevating platform being connected to a lift actuator.

5. The composite container rotary forming apparatus according to claim 4, wherein the forming mandrel corresponds to a shape of a composite container formed by the apparatus.

6. The composite container rotary forming apparatus according to claim 5, wherein the shape of the composite container is selected from the group consisting of circular, rectangular, and polygonal.

7. The composite container rotary forming apparatus according to claim 1, wherein the extraction assembly comprises a discharge rail connected to a transfer cylinder, a front end of the transfer cylinder having a discharge gripper configured to grip a composite container.

8. The composite container rotary forming apparatus according to claim 7, wherein a product collection magazine is provided between the mounting base of the discharge mechanism and the extraction assembly, and the discharge gripper is movable to the product collection magazine for storage after gripping the composite container.

9. The composite container rotary forming apparatus according to claim 4, wherein each of the plurality of rim curling stations is connected to a hot-air heater configured to deliver hot air to an edge of the forming mandrel through a hot-air duct to plasticize an upper rim of a plastic container.
